(19) United States
(12) Patent Application Publication
(10) Pub. No.: US 2021/0020395 A1
(43) Pub. Date: Jan. 21, 2021

(54) Smart Light Switches

(71) Applicant: Derek ODEGARD, Astoria, NY (US)

(72) Inventors: Derek Odegard, Astoria, NY (US); Zhijing Wang, Boxborough, MA (US)

(21) Appl. No.: 16/755,809

(22) PCT Filed: Oct. 15, 2018
(86) PCT No.: PCT/US18/55900

§ 371 Date: Apr. 13, 2020

Related U.S. Application Data
(60) Provisional application No. 62/572,102, filed on Oct. 13, 2017.

(51) Int. Cl. H01H 25/06; H05B 45/28; H05B 45/24; H05B 47/19

(52) U.S. Cl. CPC H01H 25/06; H05B 47/19; H05B 45/24; H05B 45/28

(57) ABSTRACT

The invention features environmental conditions control systems, including an environmental conditions control system including one or more light sources, a thermostat, and a smart light switch including a knob and a plurality of buttons, the smart light switch in electronic communication with the one or more light sources and the thermostat such that the knob and the plurality of buttons are configured to control a light intensity of the one or more light sources and a temperature setting of the thermostat.

### CROSS-REFERENCE TO RELATED APPLICATIONS

The present application claims priority to U.S. Provisional Patent Application No. 62/572,102, filed Oct. 13, 2017, the disclosures and teachings of which are incorporated herein by reference.

### TECHNICAL FIELD

The present invention relates to smart light switches, preferably smart light switches used in a home environment.

### BACKGROUND OF THE INVENTION

Light switches are ubiquitous in our daily environments, including in homes and offices. More recently, smart devices have been integrated into these environments for the purposes of not only controlling light, but also managing temperature, i.e., acting as a thermostat. Given these technological advancements, there is a need for superior means of replacing traditional light switches with multi-functional smart light switches capable of environmental condition detection and adjustment, color lighting control and adjustment, and/or self-powering.

### SUMMARY OF THE INVENTION

In general, in one aspect, the invention features an environmental conditions control system, including one or more light sources, a thermostat, and a smart light switch including a knob and a plurality of buttons, the smart light switch in electronic communication with the one or more light sources and the thermostat such that the knob and the plurality of buttons are configured to control a light intensity of the one or more light sources and a temperature setting of the thermostat.

Implementations of the invention may include one or more of the following features. The knob may include a screen display composed of an LCD, LED, OLED, QLED, plasma, or e-ink screen. The plurality of buttons may be four buttons disposed in a quadrant-based arrangement on the smart light switch. The plurality of buttons may be configured to generate one or more preset actions upon being pressed, the preset actions relating to adjustment of the light intensity of the one or more light sources or adjustment of the temperature setting of the thermostat. The system may further include an audio device, where the smart light switch is in electronic communication with the audio device such that the knob and/or the plurality of buttons are configured to control an audio aspect of the audio device. The audio aspect may be an audio volume or an audio composition. The electronic communication may be a wireless communication, and the wireless communication may be one or more of a BLUETOOTH-based communication, a WI-FI-based communication, a ZIGBEE-based communication, and a THREAD-based communication. The electronic communication may be additionally controlled by a mobile device application configured on a mobile device. The smart light switch may further include one or more sensors, and the one or more sensors may be one or more of a light sensor, a temperature sensor, a humidity sensor, and a motion sensor. The smart light switch may further include an internal speaker and/or a microphone.

In general, in another aspect, the invention features an environmental conditions control system, including one or more light sources, each of the one or more light sources being an RGB LED, and a smart light switch including a printed circuit board assembly, a knob, and a plurality of buttons, the smart light switch in electronic communication with the one or more light sources such that the printed circuit board assembly is configured to control a color of the one or more light sources and the knob and the plurality of buttons are configured to adjust the color of the one or more light sources.

Implementations of the invention may include one or more of the following features. The electronic communication may be a wireless communication, and the wireless communication may be one or more of a BLUETOOTH-based communication, a WI-FI-based communication, and a ZIGBEE-based communication. The electronic communication may be additionally controlled by a mobile device application configured on a mobile device.

In general, in another aspect, the invention features an environmental conditions control system, including a smart light switch having a self-powered wireless transmitter assembly with a mechanical actuation mechanism, an energy-harvesting mechanism, and a circuitry configured to convert harvested energy from the energy-harvesting mechanism into a wireless signal upon actuation of the mechanical actuation mechanism, a light dimming circuitry, and a wireless receiver configured to send a control signal to the light dimming circuitry upon receipt of the wireless signal from the wireless transmitter, and one or more light sources in electronic communication with the smart light switch such that the light dimming circuitry is configured to control a light intensity of the one or more light sources.

Implementations of the invention may include one or more of the following features. The mechanical actuation mechanism may be one or more of a dual polarity actuator, a button actuator, and a slide actuator. The energy-harvesting mechanism may be one or more of a piezoelectric element and an electromagnetic system. The light dimming circuitry may be configured to control a preset light intensity adjustment of the one or more light sources, and/or power off the one or more light sources if a light intensity level of the one or more light sources is below a preset light intensity level.

### BRIEF DESCRIPTION OF THE DRAWINGS

FIG. 1 shows a front side view of a smart light switch according to one embodiment of the present invention;

FIG. 2 shows a perspective view of the smart light switch of FIG. 1; and

FIG. 3 shows a side view of the smart light switch of FIG. 1.

### DETAILED DESCRIPTION OF THE INVENTION

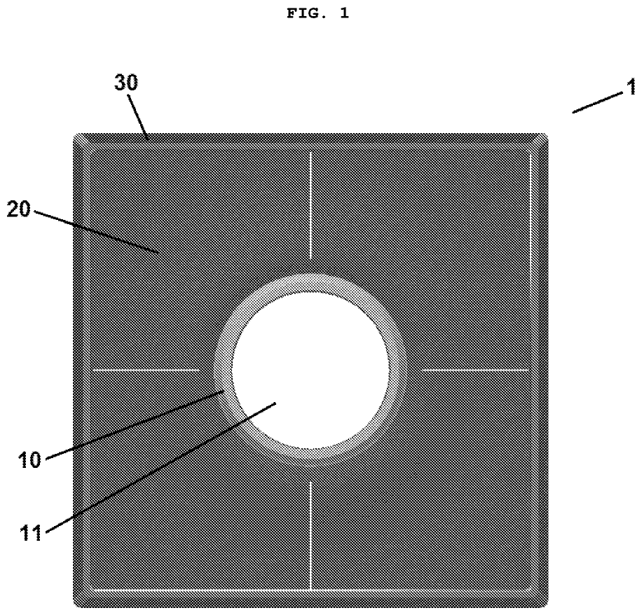

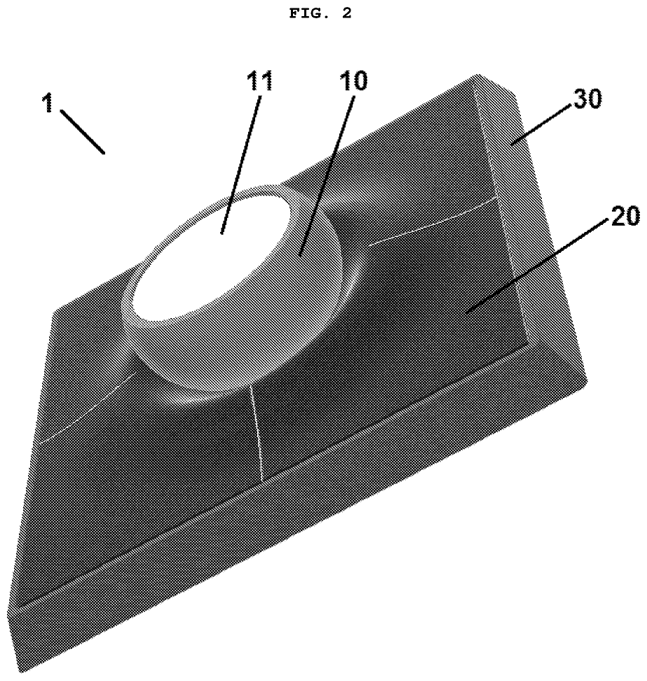

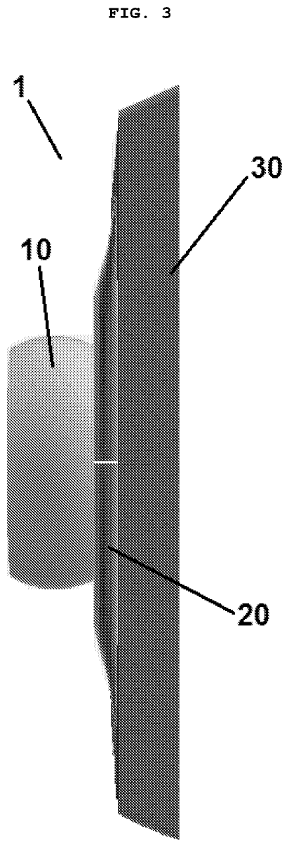

FIGS. 1-3 provide several views of a smart light switch according to one embodiment of the present invention. Smart light switch 1 includes several elements, specifically knob 10 having a knob screen 11, a plurality of function buttons 20, and a frame 30.

Knob 10 may be configured to rotate and/or to be pushed in. Knob 10 may be configured to rotate while being pushed in. Knob 10 may be configured to adjust certain environment settings, such as lighting brightness, audio volume, thermostat temperature, and the like. Preferably, knob screen 11 does not rotate upon rotation of knob 10. Knob screen 11 may be composed of any commonly-known display screen technology, including LCD, LED, OLED, QLED, plasma, e-ink, and the like. In a preferred embodiment, the display of knob screen 11 is an e-ink display.

The plurality of function buttons 20 may be set around knob 10. The smart light switch of the present invention may include any plurality of function buttons. In a preferred embodiment, the smart light switch includes four function buttons in a quadrant-based arrangement. Each function button 20 is capable of being pressed individually. Accordingly, each function button 20 may be configured to represent a preset function relating to lighting, audio, and/or temperature. Present functions may include lighting scenes, music playlists, and automation in certain Thread network protocol products.

The smart light switch of the present invention may be configured to control traditional wired lights. Moreover, the smart light switch may be configured to control third party smart environment products that accept connections via BLUETOOTH Low Energy (BLE), WI-FI, ZIGBEE, and/or Thread protocols, including but not limited to PHILIPS HUE, LIFX, SONOS, NEST, SMARTTHINGS, and WINK. In a preferable embodiment, the smart light switch of the present invention is capable of making outgoing connections only, except in the instance of accepting connections from an application specifically designed for the smart light switch of the present invention. BLE may be used with respect to such connections. The application may be available on IOS- and/or ANDROID-capable mobile devices. Firmware updates may be performed by the smart light switch, such as on a regular schedule, as opposed to receiving updates pushed from a cloud source.

The smart light switch may be approximately the size of a U.S. double-gang light switch. Moreover, the electronic components of the smart light switch may be compact enough to fit over or within a U.S. single-gang box. Therefore, the smart light switch of the present invention may be utilized in replacing both single switches and double switches.

The smart light switch may include one or more sensors. The sensor(s) may detect light, temperature/humidity, and/or motion. A light sensor may be directed to efficiency purposes, such as dimming lights when a covered area is already receiving sufficient natural light. A motion sensor may react to the approach or the departure of an individual in the covered area. Upon approach of the individual, the smart light switch may turn on or otherwise become active. Upon the departure of the individual, the smart light switch may turn off, go into sleep mode, or otherwise become inactive.

The smart light switch may include an internal speaker. The internal speaker may be capable of communicating feedback regarding an individual's interactions with the smart light switch. The smart light switch may also include a microphone. The smart light switch may be capable of setting a timer and/or a schedule for lighting controlled by the smart light switch.

Additionally, another aspect of a smart light switch according to one embodiment of the present invention is a light color control aspect. A smart light switch may include a circuit board, such as a printed circuit board assembly (PCBA), which may be disposed in a plastic or metal housing, where the circuit board is configured to control light color of an associated multi-color light source by adjusting the allocation or proportion of each color in the multi-color light source. The multi-color light source may be, but is not limited to, a red-blue-green (RGB) light-emitting diode (LED). Light color control may involve discrete color changes or continuous color changes.

The smart light switch of this embodiment may also have radio frequency (RF) communication capabilities including but not limited to BLUETOOTH Low Energy (BLE), WI-FI, ZIGBEE, and the like, such that the smart light switch communicates and controls the associated light(s) via RF means. The color may be controlled and/or adjusted by a knob or button disposed on the body of the smart light switch or by a mobile device application associated with the smart light switch. For example, the mobile device may be able to communicate with the smart light switch through the wireless communication capability.

Additionally, another aspect of a smart light switch according to one embodiment of the present invention includes a self-powering feature. A switch of this embodiment may also have a dimmer feature. The dimmer feature may be one or more of a preset light intensity adjustment, a complete power off, a complete power off upon light levels falling below a preset level, and the like. The switch may have an energy-harvesting mechanism for self-powering an RF transmitter. The energy-harvesting mechanism may include but is not limited to a piezoelectric element, an electromagnetic system, and the like. A mechanical action may need to be performed in order to capture energy, with such action including but not limited to pushing a button, moving a slide, and the like. Accordingly, a mechanical actuation mechanism may be a button actuator, a slide actuator, or a dual polarity actuator. In this embodiment, the switch does not need to access any wiring harness in order to function.

The switch of this embodiment may include an RF transmitter assembly having a mechanical actuation mechanism, an energy-harvesting mechanism, and circuitry configured to convert harvested energy into an RF signal. The switch may also include a light dimming circuitry and a wireless receiver configured to send control signals to the light dimming circuitry after receiving the signal from the RF transmitter. The RF signal may be one signal or multiple signals. The wireless receiver may send control signals corresponding to each received RF signal.

The embodiments and examples above are illustrative, and many variations can be introduced to them without departing from the spirit and scope of the disclosure or from the scope of the invention. For example, elements and/or features of different illustrative and exemplary embodiments herein may be combined with each other and/or substituted with each other within the scope of this disclosure. For a better understanding of the invention, its operating advantages and the specific objects attained by its uses, reference should be had to the drawings and descriptive matter, in which there is illustrated a preferred embodiment of the invention.

What is claimed is:

1. An environmental conditions control system, comprising:
one or more light sources;
a thermostat; and
a smart light switch including a knob and a plurality of buttons, the smart light switch in electronic communication with the one or more light sources and the thermostat such that the knob and the plurality of buttons are configured to control a light intensity of the one or more light sources and a temperature setting of the thermostat.

2. The environmental conditions control system of claim 1, wherein the knob includes a screen display composed of an LCD, LED, OLED, QLED, plasma, or e-ink screen.

3. The environmental conditions control system of claim 1, wherein the plurality of buttons are four buttons disposed in a quadrant-based arrangement on the smart light switch.

4. The environmental conditions control system of claim 1, wherein the plurality of buttons are configured to generate one or more preset actions upon being pressed, the preset actions relating to adjustment of the light intensity of the one or more light sources or adjustment of the temperature setting of the thermostat.

5. The environmental conditions control system of claim 1, further comprising an audio device, wherein the smart light switch is in electronic communication with the audio device such that the knob and/or the plurality of buttons are configured to control an audio aspect of the audio device.

6. The environmental conditions control system of claim 5, wherein the audio aspect is an audio volume or an audio composition.

7. The environmental conditions control system of claim 1, wherein the electronic communication is a wireless communication.

8. The environmental conditions control system of claim 7, wherein the wireless communication is one or more of a BLUETOOTH-based communication, a WI-FI-based communication, a ZIGBEE-based communication, and a THREAD-based communication.

9. The environmental conditions control system of claim 1, wherein the electronic communication is additionally controlled by a mobile device application configured on a mobile device.

10. The environmental conditions control system of claim 1, wherein the smart light switch further includes one or more sensors, and wherein the one or more sensors are one or more of a light sensor, a temperature sensor, a humidity sensor, and a motion sensor.

11. The environmental conditions control system of claim 1, wherein the smart light switch further includes an internal speaker and/or a microphone.

12. An environmental conditions control system, comprising:
one or more light sources, each of the one or more light sources being an RGB LED; and
a smart light switch including a printed circuit board assembly, a knob, and a plurality of buttons, the smart light switch in electronic communication with the one or more light sources such that the printed circuit board assembly is configured to control a color of the one or more light sources and the knob and the plurality of buttons are configured to adjust the color of the one or more light sources.

13. The environmental conditions control system of claim 12, wherein the electronic communication is a wireless communication.

14. The environmental conditions control system of claim 13, wherein the wireless communication is one or more of a BLUETOOTH-based communication, a WI-FI-based communication, and a ZIGBEE-based communication.

15. The environmental conditions control system of claim 12, wherein the electronic communication is additionally controlled by a mobile device application configured on a mobile device.

16. An environmental conditions control system, comprising:
a smart light switch comprising:
a self-powered wireless transmitter assembly comprising:
a mechanical actuation mechanism;
an energy-harvesting mechanism; and
a circuitry configured to convert harvested energy from the energy-harvesting mechanism into a wireless signal upon actuation of the mechanical actuation mechanism;
a light dimming circuitry; and
a wireless receiver configured to send a control signal to the light dimming circuitry upon receipt of the wireless signal from the wireless transmitter; and
one or more light sources in electronic communication with the smart light switch such that the light dimming circuitry is configured to control a light intensity of the one or more light sources.

17. The environmental conditions control system of claim 16, wherein the mechanical actuation mechanism is one or more of a dual polarity actuator, a button actuator, and a slide actuator.

18. The environmental conditions control system of claim 16, wherein the energy-harvesting mechanism is one or more of a piezoelectric element and an electromagnetic system.

19. The environmental conditions control system of claim 16, wherein the light dimming circuitry is configured to control a preset light intensity adjustment of the one or more light sources.

20. The environmental conditions control system of claim 16, wherein the light dimming circuitry is configured to power off the one or more light sources if a light intensity level of the one or more light sources is below a preset light intensity level.
